(19) United States
(12) Patent Application Publication
(10) Pub. No.: US 2025/0211397 A1
(43) Pub. Date: Jun. 26, 2025

(54) TECHNIQUES FOR SIGNAL STRENGTH MONITORING

(71) Applicant: QUALCOMM Incorporated, San Diego, CA (US)

(72) Inventors: Jian TAO, Shanghai (CN); Liang XU, Shanghai (CN); Wenwen ZHAO, Xuyi (CN); Tianming HUANG, Shanghai (CN); Zhonghua HUANG, Shanghai (CN); Jun LI, Shanghai (CN); Jingrui ZHU, Shanghai (CN)

(21) Appl. No.: 18/848,491

(22) PCT Filed: May 16, 2023
(86) PCT No.: PCT/CN2023/094460

§ 371 Date: Sep. 18, 2024

(30) Foreign Application Priority Data
May 17, 2022 (WO) PCT/CN2022/093267

(51) Int. Cl. H04L 5/00; H04B 17/318; H04L 1/06; H04L 1/1829

(52) U.S. Cl. CPC H04L 5/0053; H04B 17/328; H04L 1/0687; H04L 1/1858

(57) ABSTRACT

Methods, systems, and devices for wireless communication are described. A wireless station (STA) may monitor characteristics of signaling with an access point (AP) in a wireless local area network (WLAN). If a characteristic of the signaling from the AP falls below a first threshold, the STA may transmit a feedback message in a first portion of a bandwidth and refrain from transmitting duplicate feedback messages in a second portion of the bandwidth. In some examples, the STA may enable or disable duplication for transmitting the feedback message based on a feedback message transmit power threshold. Additionally, or alternatively, the STA may monitor signaling on two connected transmission chains. Based on a coding rate threshold or a signal strength threshold, the STA may increase an output power of the chain with the lower signal strength to give an extra link budget for transmissions to the AP.

### CROSS REFERENCES

The present Application is a 371 national stage filing of International PCT Application No. PCT/CN2023/094460 by TAO et al., entitled “TECHNIQUES FOR SIGNAL STRENGTH MONITORING,” filed May 16, 2023; which claims priority to International Patent Application No. PCT/CN2022/093267 by TAO et al. entitled “TECHNIQUES FOR SIGNAL STRENGTH MONITORING,” filed May 17, 2022, each of which is assigned to the assignee hereof, and each of which is expressly incorporated by reference in its entirety herein.

### BACKGROUND

The following relates to wireless communication, including techniques for signal strength monitoring.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, an STA may communicate with an associated AP via downlink (DL) and uplink (UL). The DL (or forward link) may refer to the communication link from the AP to the STA, and the UL (or reverse link) may refer to the communication link from the station to the AP.

In some cases, an STA may provide feedback to an AP in response to DL transmissions. However, for some use cases, conventional feedback techniques may be deficient or sub-optimal in some current configurations.

### SUMMARY

The described techniques relate to improved methods, systems, devices, or apparatuses that support techniques for signal strength monitoring. Generally, the described techniques provide for enabling a wireless station (STA) to monitor characteristics of signaling from an access point (AP) in a wireless local area network (WLAN) and adjust transmission parameters based on the monitoring. In some examples, the STA may monitor a received signal strength indicator (RSSI) of downlink (DL) transmissions from the AP. If the RSSI of the signaling from the AP falls below a first threshold, the STA may transmit a feedback message in a first portion of a bandwidth and refrain from transmitting duplicate feedback messages in a second portion of the bandwidth. If the RSSI subsequently improves and rises above a second threshold, the STA may return to transmitting duplicated feedback messages that collectively span the bandwidth.

In some examples, the STA may determine whether to enable or disable duplicated feedback messages for the signaling based on a feedback message transmit power threshold. The duplicate feedback messages may be associated with a first transmit power, while a single feedback message in the first portion of the bandwidth may be associated with a second transmit power. The STA may determine a difference value between the first transmit power and the second transmit power and may compare the difference value to the feedback message transmit power threshold. If the difference value is greater than the feedback message transmit power threshold, the STA may continue to transmit (or return to transmitting) the duplicated feedback messages. If the difference value is less than the feedback message transmit power threshold, the STA may disable the duplicated feedback messages, and may instead transmit a feedback message in the first portion of the bandwidth.

Additionally, or alternatively, the STA may monitor a coding rate of packets received in the signaling. If the coding rate falls below a first threshold, the STA may transmit a single feedback message without duplication. If the coding rate subsequently improves above a second threshold, the STA may return to transmitting duplicated feedback messages that collectively span the bandwidth. Additionally, or alternatively, the STA may monitor signaling on two connected transmission chains. If the coding rate falls below a rate threshold, and a difference between the RSSI of the two chains is above a difference threshold, the STA may increase an output power of the chain with the lower RSSI to give an extra link budget for transmissions to the AP.

A method for wireless communication at a wireless station is described. The method may include monitoring for a signal from an access point, comparing a characteristic of the signal with a threshold, the characteristic determined based on the monitoring and being one of a received signal strength indicator associated with the signal or a coding rate associated with a modulation and coding scheme of a set of packets received in the signal, transmitting a first instance of a feedback message pertaining to the signal in a first portion of a bandwidth, and refraining, based on the characteristic being less than the threshold, from concurrently transmitting a second instance of the feedback message in a second portion of the bandwidth.

An apparatus for wireless communication at a wireless station is described. The apparatus may include a processor, memory coupled with the processor, and instructions stored in the memory. The instructions may be executable by the processor to cause the apparatus to monitor for a signal from an access point, compare a characteristic of the signal with a threshold, the characteristic determined based on the monitoring and being one of a received signal strength indicator associated with the signal or a coding rate associated with a modulation and coding scheme of a set of packets received in the signal, transmit a first instance of a feedback message pertaining to the signal in a first portion of a bandwidth, and refrain, based on the characteristic being less than the threshold, from concurrently transmitting a second instance of the feedback message in a second portion of the bandwidth.

Another apparatus for wireless communication at a wireless station is described. The apparatus may include means for monitoring for a signal from an access point, means for comparing a characteristic of the signal with a threshold, the characteristic determined based on the monitoring and being one of a received signal strength indicator associated with the signal or a coding rate associated with a modulation and coding scheme of a set of packets received in the signal, means for transmitting a first instance of a feedback message pertaining to the signal in a first portion of a bandwidth, and means for refraining, based on the characteristic being less than the threshold, from concurrently transmitting a second instance of the feedback message in a second portion of the bandwidth.

A non-transitory computer-readable medium storing code for wireless communication at a wireless station is described. The code may include instructions executable by a processor to monitor for a signal from an access point, compare a characteristic of the signal with a threshold, the characteristic determined based on the monitoring and being one of a received signal strength indicator associated with the signal or a coding rate associated with a modulation and coding scheme of a set of packets received in the signal, transmit a first instance of a feedback message pertaining to the signal in a first portion of a bandwidth, and refrain, based on the characteristic being less than the threshold, from concurrently transmitting a second instance of the feedback message in a second portion of the bandwidth.

Some examples of the method, apparatuses, and non-transitory computer-readable medium described herein may further include operations, features, means, or instructions for monitoring, after the transmitting, for a second signal from the access point, comparing, from the second signal and with a second threshold, a same characteristic as identified from the first signal, and transmitting a second feedback message pertaining to the second signal, where the second feedback message may be transmitted with frequency-based duplication based on the same characteristic being greater than the second threshold.

In some examples of the method, apparatuses, and non-transitory computer-readable medium described herein, the second feedback message spans the bandwidth.

In some examples of the method, apparatuses, and non-transitory computer-readable medium described herein, the second feedback message includes a non-high-throughput acknowledgement message.

In some examples of the method, apparatuses, and non-transitory computer-readable medium described herein, the threshold may be a received signal strength indicator threshold and the characteristic may be the received signal strength indicator associated with the signal.

In some examples of the method, apparatuses, and non-transitory computer-readable medium described herein, the threshold may be a coding rate threshold and the characteristic may be the coding rate associated with the modulation and coding scheme of the set of packets received in the signal.

In some examples of the method, apparatuses, and non-transitory computer-readable medium described herein, the coding rate may be based on a quantity of spatial streams associated with the signal.

A method for wireless communication at a wireless station is described. The method may include monitoring for a first signal from an access point and for a second signal from the access point using a first transmission chain of the wireless station and a second transmission chain of the wireless station, respectively, comparing, with a rate threshold, a coding rate that is determined based on the monitoring, the coding rate being associated with the first signal, the second signal, or both, comparing, with a difference threshold, a difference between a first received signal strength of the first signal and a second received signal strength of the second signal, the difference determined based on the monitoring, and increasing a transmit power associated with the first transmission chain based on the coding rate being less than the rate threshold and on the difference being greater than the difference threshold, the first received signal strength of the first signal being less than the second received signal strength of the second signal.

An apparatus for wireless communication at a wireless station is described. The apparatus may include a processor, memory coupled with the processor, and instructions stored in the memory. The instructions may be executable by the processor to cause the apparatus to monitor for a first signal from an access point and for a second signal from the access point using a first transmission chain of the wireless station and a second transmission chain of the wireless station, respectively, compare, with a rate threshold, a coding rate that is determined based on the monitoring, the coding rate being associated with the first signal, the second signal, or both, compare, with a difference threshold, a difference between a first received signal strength of the first signal and a second received signal strength of the second signal, the difference determined based on the monitoring, and increase a transmit power associated with the first transmission chain based on the coding rate being less than the rate threshold and on the difference being greater than the difference threshold, the first received signal strength of the first signal being less than the second received signal strength of the second signal.

Another apparatus for wireless communication at a wireless station is described. The apparatus may include means for monitoring for a first signal from an access point and for a second signal from the access point using a first transmission chain of the wireless station and a second transmission chain of the wireless station, respectively, means for comparing, with a rate threshold, a coding rate that is determined based on the monitoring, the coding rate being associated with the first signal, the second signal, or both, means for comparing, with a difference threshold, a difference between a first received signal strength of the first signal and a second received signal strength of the second signal, the difference determined based on the monitoring, and means for increasing a transmit power associated with the first transmission chain based on the coding rate being less than the rate threshold and on the difference being greater than the difference threshold, the first received signal strength of the first signal being less than the second received signal strength of the second signal.

A non-transitory computer-readable medium storing code for wireless communication at a wireless station is described. The code may include instructions executable by a processor to monitor for a first signal from an access point and for a second signal from the access point using a first transmission chain of the wireless station and a second transmission chain of the wireless station, respectively, compare, with a rate threshold, a coding rate that is determined based on the monitoring, the coding rate being associated with the first signal, the second signal, or both, compare, with a difference threshold, a difference between a first received signal strength of the first signal and a second received signal strength of the second signal, the difference determined based on the monitoring, and increase a transmit power associated with the first transmission chain based on the coding rate being less than the rate threshold and on the difference being greater than the difference threshold, the first received signal strength of the first signal being less than the second received signal strength of the second signal.

Some examples of the method, apparatuses, and non-transitory computer-readable medium described herein may further include operations, features, means, or instructions for transmitting a third signal to the access point using the first transmission chain of the wireless station according to the increased transmit power.

In some examples of the method, apparatuses, and non-transitory computer-readable medium described herein, the coding rate may be based on a quantity of spatial streams associated with the first signal, the second signal, or both.

In some examples of the method, apparatuses, and non-transitory computer-readable medium described herein, the first signal includes a first instance of a downlink message and the second signal includes a second instance of the downlink message.

In some examples of the method, apparatuses, and non-transitory computer-readable medium described herein, the first signal and the second signal may be a same signal.

In some examples of the method, apparatuses, and non-transitory computer-readable medium described herein, the first transmission chain and the second transmission chain may be associated with a multiple-input multiple-output configuration at the wireless station.

In some examples of the method, apparatuses, and non-transitory computer-readable medium described herein, the coding rate includes a combined coding rate associated with a modulation and coding scheme of a set of packets received in the first signal and the second signal.

In some examples of the method, apparatuses, and non-transitory computer-readable medium described herein, the coding rate may be associated with a modulation and coding scheme of a set of packets received in the first signal.

A method for wireless communication at a wireless station is described. The method may include monitoring for a signal from an access point, comparing a difference value between a first transmit power of a first feedback message type and a second transmit power of a second feedback message type to a threshold value, the first feedback message type and the second feedback message type associated with a feedback message pertaining to the signal, and transmitting, in a first portion of a bandwidth, a first instance of the feedback message in accordance with the first feedback type or the second feedback type based on the difference value satisfying the threshold value.

An apparatus for wireless communication at a wireless station is described. The apparatus may include a processor, memory coupled with the processor, and instructions stored in the memory. The instructions may be executable by the processor to cause the apparatus to monitor for a signal from an access point, compare a difference value between a first transmit power of a first feedback message type and a second transmit power of a second feedback message type to a threshold value, the first feedback message type and the second feedback message type associated with a feedback message pertaining to the signal, and transmit, in a first portion of a bandwidth, a first instance of the feedback message in accordance with the first feedback type or the second feedback type based on the difference value satisfying the threshold value.

Another apparatus for wireless communication at a wireless station is described. The apparatus may include means for monitoring for a signal from an access point, means for comparing a difference value between a first transmit power of a first feedback message type and a second transmit power of a second feedback message type to a threshold value, the first feedback message type and the second feedback message type associated with a feedback message pertaining to the signal, and means for transmitting, in a first portion of a bandwidth, a first instance of the feedback message in accordance with the first feedback type or the second feedback type based on the difference value satisfying the threshold value.

A non-transitory computer-readable medium storing code for wireless communication at a wireless station is described. The code may include instructions executable by a processor to monitor for a signal from an access point, compare a difference value between a first transmit power of a first feedback message type and a second transmit power of a second feedback message type to a threshold value, the first feedback message type and the second feedback message type associated with a feedback message pertaining to the signal, and transmit, in a first portion of a bandwidth, a first instance of the feedback message in accordance with the first feedback type or the second feedback type based on the difference value satisfying the threshold value.

Some examples of the method, apparatuses, and non-transitory computer-readable medium described herein may further include operations, features, means, or instructions for refraining from concurrently transmitting a second instance of the feedback message in a second portion of the bandwidth based on the difference value being less than the threshold value, where the first instance of the feedback message may be transmitted in accordance with the second feedback type.

In some examples of the method, apparatuses, and non-transitory computer-readable medium described herein, the first instance of the feedback message spans the first portion of the bandwidth.

Some examples of the method, apparatuses, and non-transitory computer-readable medium described herein may further include operations, features, means, or instructions for transmitting a second instance of the feedback message, where the first instance of the feedback message and the second instance of the feedback message may be transmitted in accordance with the first feedback message type based on the difference value being greater than the threshold value.

In some examples of the method, apparatuses, and non-transitory computer-readable medium described herein, the first instance of the feedback message and the second instance of the feedback message may be transmitted with frequency-based duplication.

In some examples of the method, apparatuses, and non-transitory computer-readable medium described herein, the first instance of the feedback message includes an acknowledgement message for the signal and the second instance of the feedback message includes a duplicate of the acknowledgement message.

In some examples of the method, apparatuses, and non-transitory computer-readable medium described herein, the first feedback message type includes a non-high-throughput acknowledgment message type.

In some examples of the method, apparatuses, and non-transitory computer-readable medium described herein, the first instance of the feedback message and the second instance of the feedback message span the bandwidth.

### BRIEF DESCRIPTION OF THE DRAWINGS

FIG. 1 illustrates an example of a wireless communication system that supports techniques for signal strength monitoring in accordance with aspects of the present disclosure.

FIG. 2 illustrates an example of a wireless communication system that supports techniques for signal strength monitoring in accordance with one or more aspects of the present disclosure.

FIG. 3 illustrates an example of a wireless communication system that supports techniques for signal strength monitoring in accordance with one or more aspects of the present disclosure.

FIG. 4 illustrates an example of a process flow that supports techniques for signal strength monitoring in accordance with one or more aspects of the present disclosure.

FIG. 5 illustrates an example of a process flow that supports techniques for signal strength monitoring in accordance with one or more aspects of the present disclosure.

FIGS. 6 and 7 show block diagrams of devices that support techniques for signal strength monitoring in accordance with one or more aspects of the present disclosure.

FIG. 8 shows a block diagram of a communications manager that supports techniques for signal strength monitoring in accordance with one or more aspects of the present disclosure.

FIG. 9 shows a diagram of a system including a device that supports techniques for signal strength monitoring in accordance with one or more aspects of the present disclosure.

FIGS. 10 through 13 show flowcharts illustrating methods that support techniques for signal strength monitoring in accordance with one or more aspects of the present disclosure.

### DETAILED DESCRIPTION

In a wireless local area network (WLAN), a wireless device, which may be referred to as a station (STA) may communicate with an associated access point (AP) via downlink (DL) and uplink (UL). In some cases, the STA may experience a decrease in DL throughput from the AP when a received signal strength falls below a threshold (e.g., −80 decibel-milliwatt (dBm)). The throughput decrease may be based on a reduced reception at the AP. For example, the AP may reduce a coding rate of DL transmissions based on feedback messages received at the AP, where a received signal strength of the feedback messages may fall below a sensitivity point at the AP. Additionally, or alternatively, a UL throughput may decrease based on an orientation of antennas of the STA relative to the AP. For example, an imbalance in transmit powers of the antennas of the STA may be based on the orientation of the antennas of the STA. It may be beneficial to enable the STA to adjust feedback, transmission parameters, or both, to improve throughput and reliability of communications with the AP.

According to the techniques described herein, an STA may monitor characteristics of signaling from an AP and adjust transmission parameters based on the monitoring. In some examples, the STA may monitor a received signal strength indicator (RSSI) of DL transmissions from the AP. If the RSSI of the signaling from the AP falls below a first threshold (e.g., −80 dBm), the STA may transmit a feedback message in a first portion of a bandwidth (e.g., a feedback message spanning 20 megahertz (MHz) of an 80 MHz or 160 MHz bandwidth) and refrain from transmitting duplicate feedback messages in a remaining portion of the bandwidth. If the RSSI subsequently improves and rises above a second threshold (e.g., −76 dBm), the STA may return to transmitting duplicated feedback messages that span the bandwidth (e.g., multiple feedback messages each spanning 20 MHz of an 80 MHz or 160 MHz bandwidth).

Additionally, or alternatively, the STA may monitor a coding rate of packets received in the signaling. If the coding rate falls below a first threshold (e.g., an index of a modulation and coding scheme (MCS), such as MCS4), the STA may transmit a single feedback message without duplication. If the coding rate subsequently improves above a second threshold (e.g., a quantity of spatial streams, such as two spatial streams), the STA may return to transmitting duplicated feedback messages that span the bandwidth. Additionally, or alternatively, the STA may monitor signaling on two connected transmission chains. If the coding rate falls below a rate threshold, and a difference between the RSSI of the two chains is above a difference threshold, the STA may increase an output power of the chain with the lower RSSI to give an extra link budget for transmissions to the AP.

In some cases, the STA may dynamically enable or disable duplicated feedback messages for the signaling, e.g., based on a feedback message transmit power threshold. The duplicate feedback messages may be configured with a first transmit power, while a single feedback message (e.g., without duplication) in the first portion of the bandwidth may be configured with a second transmit power. The STA may determine a difference value between the first transmit power and the second transmit power and may compare the difference value to the feedback message transmit power threshold. If the difference value is greater than the feedback message transmit power threshold, the STA may continue to transmit (or return to transmitting) the duplicated feedback messages. If the difference value is less than the feedback message transmit power threshold, the STA may disable the duplicated feedback messages, and may instead transmit a single feedback message in the first portion of the bandwidth.

Aspects of the disclosure are initially described in the context of a wireless communications system. Aspects of the disclosure are further illustrated by and described with reference to transmission schemes, process flows, apparatus diagrams, system diagrams, and flowcharts that relate to techniques for signal strength monitoring.

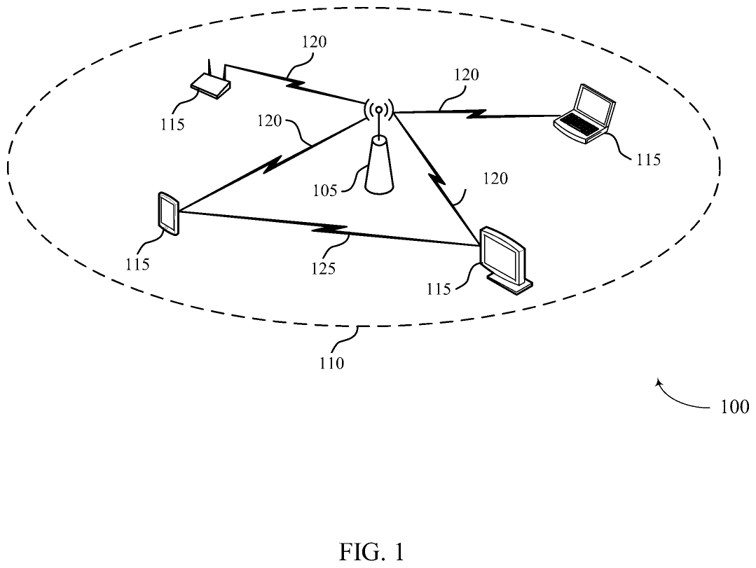

FIG. 1 illustrates a wireless communication system 100 that supports techniques for signal strength monitoring in accordance with one or more aspects of the present disclosure. In some examples, the wireless communication system 100 may be a WLAN (also known as a Wi-Fi network) configured in accordance with various aspects of the present disclosure. The wireless communication system 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the wireless communication system 100. An extended network station associated with the wireless communication system 100 may be connected to a wired or wireless distribution system that may allow multiple APs 105 to be connected in an ESS.

Although not shown in FIG. 1, an STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The wireless communication system 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and medium access control (MAC) layers from Institute of Electrical and Electronics Engineers (IEEE) 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within the wireless communication system 100.

In some cases, an STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., carrier-sense multiple access with collision avoidance (CSMA/CA)) because the STAs 115 may not refrain from transmitting on top of each other. An STA 115 whose transmissions are not identifiable, but that is within the same coverage area 110 may be known as a hidden node. CSMA/CA may be supplemented by the exchange of a ready-to-send (RTS) packet transmitted by a sending STA 115 (or AP 105) and a clear-to-send (CTS) packet transmitted by the receiving STA 115 (or AP 105). This may alert other devices within range of the sender and receiver not to transmit for the duration of the primary transmission. Thus, RTS/CTS may help mitigate a hidden node problem.

According to the techniques described herein, an STA 115 may monitor characteristics of signaling from an AP 105 and adjust transmission parameters based on the monitoring. In some examples, the STA 115 may monitor an RSSI of DL transmissions from the AP 105 on a direct wireless link 120. If the RSSI of the signaling from the AP 105 falls below a first threshold (e.g., −80 dBm), the STA 115 may transmit a feedback message in a first portion of a bandwidth (e.g., a feedback message spanning 20 MHz of an 80 MHz or 160 MHz bandwidth) and refrain from transmitting duplicate feedback messages in a remaining portion of the bandwidth. If the RSSI subsequently improves and rises above a second threshold (e.g., −76 dBm), the STA 115 may return to transmitting duplicated feedback messages (e.g., non-high throughput ACK messages) that span the bandwidth (e.g., multiple feedback messages each spanning 20 MHz of an 80 MHz or 160 MHz bandwidth).

Additionally, or alternatively, the STA 115 may monitor a coding rate of packets received in the signaling. If the coding rate falls below a first threshold (e.g., an index of an MCS, such as MCS4), the STA 115 may transmit a single feedback message without duplication. If the coding rate subsequently improves above a second threshold (e.g., a quantity of spatial streams, such as two spatial streams), the STA 115 may return to transmitting duplicated feedback messages that span the bandwidth. Additionally, or alternatively, the STA 115 may monitor signaling on two connected transmission chains. If the coding rate falls below a rate threshold, and a difference between the RSSI of the two chains is above a difference threshold, the STA 115 may increase an output power of the chain with the lower RSSI to give an extra link budget for transmissions to the AP 105 on the direct wireless link 120.

In some cases, the STA may transmit duplicated feedback messages according to a first transmit power, and may transmit the single feedback message (e.g., the feedback message without duplication) according to a second transmit power. The STA may determine whether to utilize duplication in feedback messages based on a comparison of the first transmit power and the second transmit power. For example, the STA may determine a difference value between the first transmit power and the second transmit power. The STA may compare the difference value to the feedback message transmit power threshold. If the difference value is greater than the feedback message transmit power threshold, the STA may utilize duplicated feedback messages (e.g., may continue to transmit, or may return to transmitting, the duplicated feedback messages). If the difference value is less than the feedback message transmit power threshold, the STA may disable the duplicated feedback messages, and may instead transmit a feedback message in the first portion of the bandwidth.

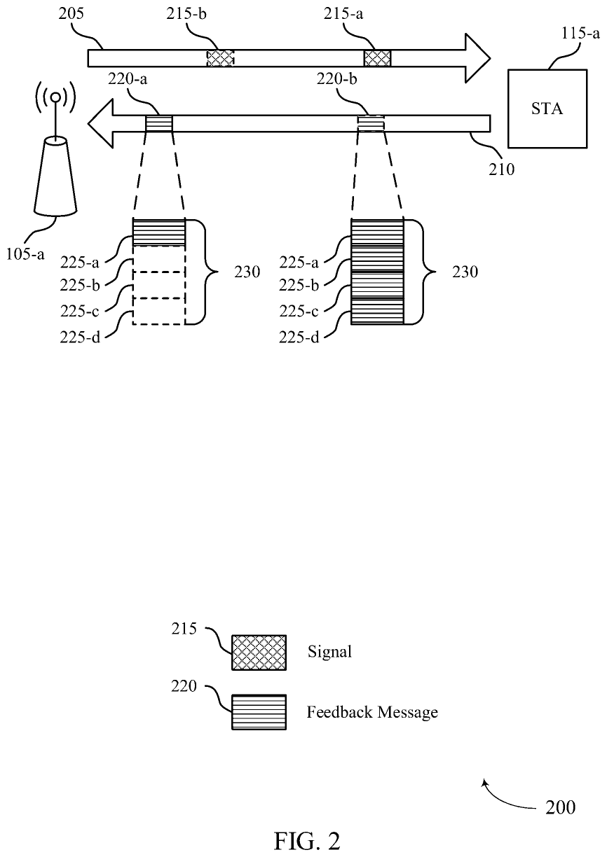

FIG. 2 illustrates an example of a wireless communication system 200 that supports techniques for signal strength monitoring in accordance with one or more aspects of the present disclosure. In some examples, the wireless communication system 200 may be a WLAN (also known as a Wi-Fi network) configured in accordance with various aspects of the present disclosure. The wireless communications system 200 may implement or be implemented by aspects of the wireless communications system 100 as described with reference to FIG. 1. For example, the wireless communications system 200 may include an AP 105-a and an STA 115-a, which may be examples of corresponding devices described with reference to FIG. 1. The wireless communications system 200 may support improvements to communication throughput and reliability, among other benefits.

The AP 105-a may transmit to the STA 115-a on a DL 205, and the STA 115-a may transmit to the AP 105-a on a UL 210. In some examples, the STA 115-a may transmit in a bandwidth 230, where each portion 225 of the bandwidth 230 may be associated with a respective channel of the UL 210. For example, a portion 225-a may be associated with a primary channel of the UL 210.

In some cases, a throughput on the DL 205 may decrease (e.g., down to 300 megabits per second (Mbps)) when an RSSI falls below a threshold (e.g., −80 dBm). The throughput decrease may be based on a reduction in a coding rate of packets received on the DL 205. For example, the STA 115-a may receive packets associated with a reduced MCS (e.g., MCS1 or MCS2, which may be less than MCS4) or on a reduced quantity of spatial streams (e.g., one spatial stream, rather than two spatial streams). In some cases, the throughput decrease may be based on a reduced reception at the AP 105-a. For example, the AP 105-a may receive a portion of a feedback message 220 (e.g., a portion less than 20 MHz of an 80 MHz or 160 MHz bandwidth 230), and an RSSI of signaling received at the AP 105-a may be less (e.g., 9 dB lower) than expected. The reduced RSSI may be less than a sensitivity point of a feedback frame rate (e.g., 24 Mbps), and the AP 105-a may respond by reducing the throughput on the DL 205.

According to the techniques described herein, the STA 115-a may monitor characteristics of signaling from the AP 105-a and adjust transmission parameters based on the monitoring. In some examples, the STA 115-a may monitor an RSSI of a signal 215-a on the DL 205. If the RSSI of the signal 215-a is below a first threshold (e.g., −80 dBm), the STA 115-a may transmit a feedback message 220-a (e.g., an acknowledgment (ACK) message) in the portion 225-a (e.g., the primary channel of the UL 210) of the bandwidth 230 and refrain from transmitting duplicates of the feedback message 220-a in a remaining portion 225 (e.g., a portion 225-b, 225-c, 225-d, or any combination thereof) of the bandwidth 230. For example, the feedback message 220-a may span 20 MHz of the 80 MHz bandwidth 230.

In some examples, the STA 115-a may subsequently monitor for a signal 215-b on the DL 205. If the RSSI of the signal 215-b is above a second threshold (e.g., −76 dBm), the STA 115-a may transmit duplicates of a feedback message 220-b (e.g., an ACK message, such as a non-high-throughput ACK message) in portions 225 that span the bandwidth 230. For example, each duplicate of the feedback message 220-b may be transmitted in a respective portion 225 spanning 20 MHz of the 80 MHz bandwidth 230.

Additionally, or alternatively, the STA 115-a may monitor a coding rate of packets received in the signal 215-a. If the coding rate is below a first threshold (e.g., an index of an MCS, such as MCS4), the STA 115-a may transmit the feedback message 220-a in the portion 225-a without duplication. If a coding rate of the subsequent signal 215-b is above a second threshold (e.g., a quantity of spatial streams, such as two spatial streams), the STA 115-a may transmit duplicates of the feedback message 220-b in portions 225 that span the bandwidth 230.

In some cases, the STA 115-a may dynamically enable or disable duplication (e.g., frequency-based duplication) of feedback messages (e.g., feedback messages 220) pertaining to a signal (e.g., a signal 215). A first feedback message type may refer to a feedback message type that utilizes frequency-based duplication for transmission of feedback messages, such as the feedback message 220-b. A second feedback message type may refer to a feedback message type that does not use duplication for transmission of a feedback message, such as the feedback message 220-a. The STA 115-a may transmit feedback messages of the first feedback message type (e.g., non-high-throughput ACK messages) according to a first transmit power Pnon-HT, and may transmit feedback messages of the second feedback message type (e.g., a feedback message that spans a 20 MHz portion of the bandwidth 230) according to a second transmit power P_{20_MHz}.

The STA 115-a may determine whether to utilize (e.g., to enable or disable) duplication in feedback messages based on a comparison of the first transmit power and the second transmit power. For example, the STA 115-a may monitor for a signal 215 on the DL 205. To transmit feedback for the signal 215, the STA 115-a may compare the first transmit power P_{non-HT} associated with the first feedback message type to the second transmit power P_{20_MHz} associated with the second feedback message type. The STA 115-a may determine a difference value between the first transmit power and the second transmit power, e.g., may determine a value of P_{non-HT}−P_{20_MHz}.

The STA 115-a may compare the difference value to a threshold value P_{T} associated with a threshold, which may include or be an example of a feedback message transmit power threshold. The STA 115-a may select a feedback message type for transmission of a feedback message 220 based on the comparison. For example, the STA 115-a may select, as the feedback message 220, a non-high-throughput ACK message (e.g., a feedback message 220-b) or a 20 MHz ACK message (e.g., a feedback message 220-a) based on whether the difference value satisfies the threshold value.

For example, if the threshold is not satisfied (e.g., if (P_{non-HT}−P₂₀_{_{MHz}})>P_{T}), the STA 115-a may transmit a feedback message 220 according to the first feedback message type, such as the feedback message 220-b. More specifically, the STA 115-a may enable frequency-based duplication for a feedback message 220 based on the difference value being less than the threshold value. The STA 115-a may transmit duplicates (e.g., instances) of the feedback message 220-b in the portions 225 that span the bandwidth 230. For example, each duplicate of the feedback message 220-b may be transmitted in a respective portion 225 spanning 20 MHz of the 80 MHz bandwidth 230. Each duplicate of the feedback message may include the feedback for the signal 215-a.

Alternatively, if the threshold is satisfied (e.g., if (P_{non-HT}−P₂₀_{_{MHz}})<P_{T}), the STA 115-a may transmit a feedback message 220 according to the second feedback message type, such as the feedback message 220-a. The STA 115-a may disable frequency-based duplication for the feedback message 220 based on the difference value being greater than the threshold value. Accordingly, the STA 115-a may transmit the feedback message 220-a in the portion 225-a of the bandwidth 230 and may refrain from concurrently transmitting duplicates of the feedback message 220-a in remaining portions 225 (e.g., a portion 225-b, 225-c, 225-d, or any combination thereof) of the bandwidth 230. The feedback message 220-a may span 20 MHz of the 80 MHz bandwidth 230.

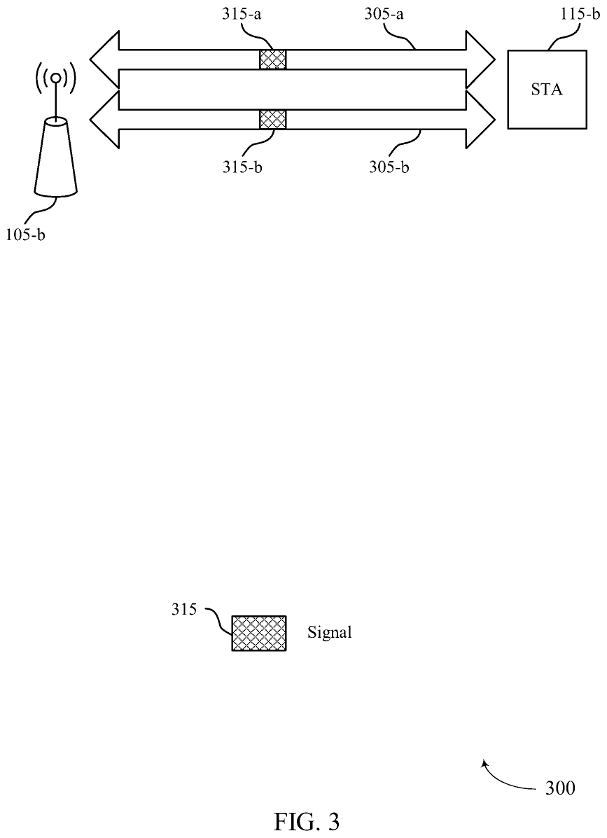

FIG. 3 illustrates an example of a wireless communication system 300 that supports techniques for signal strength monitoring in accordance with one or more aspects of the present disclosure. In some examples, the wireless communication system 300 may be a WLAN (also known as a Wi-Fi network) configured in accordance with various aspects of the present disclosure. The wireless communications system 300 may implement or be implemented by aspects of the wireless communications system 100 as described with reference to FIG. 1. For example, the wireless communications system 300 may include an AP 105-b and an STA 115-b, which may be examples of corresponding devices described with reference to FIG. 1. The wireless communications system 300 may support improvements to communication throughput and reliability, among other benefits.

The AP 105-b and the STA 115-b may communicate on transmission chains 305-a and 305-b. Each transmission chain 305 may be associated with a respective antenna at the STA 115-b. In some cases, a throughput on a UL of the transmission chains 305 may decrease (e.g., below 100 Mbps) based on an orientation of the antennas at the STA 115-b with respect to the AP 105-b. For example, based on a transmission mode of the antennas (e.g., a radiation mode or a conductive mode), the antennas may be unable to sustain a coding rate or a quantity of spatial streams associated with the UL, and the transmissions may drop to using a lower coding rate (e.g., an MCS) or fewer spatial streams, which may lead to the decrease in throughput.

According to the techniques described herein, the STA 115-b may monitor for signals 315-a and 315-b on the transmission chains 305-a and 305-b, respectively. In some examples, the signals 315-a and 315-b may be instances of a same signal 315 (e.g., instances of a DL message), or the signals 315-a and 315-b may be different signals 315. If a coding rate of the signal 315-a, the signal 315-b, or both, is less than a rate threshold (e.g., MCS2 with two spatial streams), and a difference between an RSSI of the signals 315 is greater than a difference threshold (e.g., 5 dB), the STA 115 may increase an output power (e.g., a transmit power) of the transmission chain 305 with the lower RSSI to give an extra link budget for transmissions to the AP 105-b. For example, if an RSSI of the signal 315-a on the transmission chain 305-a is 5 dB less than an RSI of the signal 315-b on the transmission chain 305-b, the STA 115-b may increase an output power of the transmission chain 305-a by 2-3 dB to improve the UL throughput.

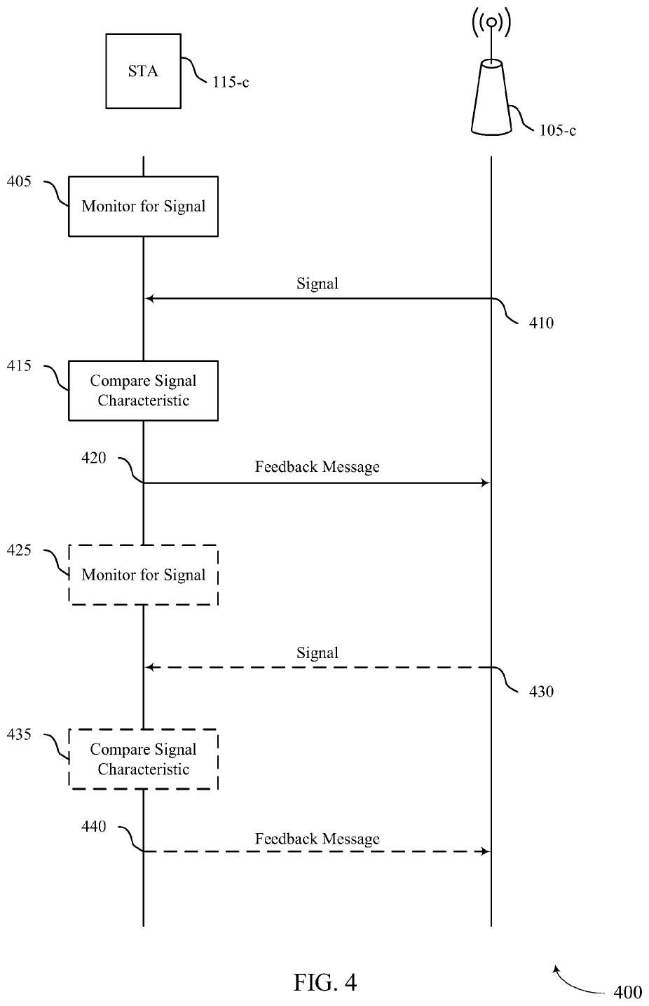

FIG. 4 illustrates an example of a process flow 400 that supports techniques for signal strength monitoring in accordance with one or more aspects of the present disclosure. In some examples, the process flow 400 may implement or be implemented by one or more aspects of wireless communications systems 100, 200, and 300. For example, the process flow 400 may include example operations associated with one or more of an AP 105-c or an STA 115-c, which may be examples of corresponding devices described with reference to FIGS. 1 through 3. In the following description of the process flow 400, the operations between the AP 105-c and the STA 115-c may be performed in a different order than the example order shown, or the operations performed by the AP 105-c and the STA 115-c may be performed in different orders or at different times. Some operations may also be omitted from the process flow 400, and other operations may be added to the process flow 400. The operations performed by the AP 105-c and the STA 115-c may support improvements to feedback operations and, in some examples, may promote improvements to communications reliability, among other benefits.

At 405, the STA 115-c may monitor for a signal from the AP 105-c, for example, on a DL channel. At 410, the STA 115-c may receive the signal.

At 415, the STA 115-c may compare a characteristic of the signal with a threshold. For example, the characteristic may be an RSSI associated with the signal, and the threshold may be an RSSI threshold (e.g., −80 dBm). Additionally, or alternatively, the characteristic may be a coding rate associated with an MCS of a set of packets received in the signal, and the threshold may be a coding rate threshold (e.g., an index of the MCS, such as MCS4). In some examples, the coding rate may be based on a quantity of spatial streams associated with the signal.

At 420, the STA 115-c may transmit to the AP 105-c a feedback message (e.g., an ACK message) pertaining to the signal. The STA 115-c may transmit an instance of the feedback message in a first portion of a bandwidth (e.g., a primary channel of a UL, which may span 20 MHz of an 80 MHz bandwidth or a 160 MHz bandwidth). In some examples, based on the characteristic of the signal satisfying the threshold (e.g., the characteristic is less than the threshold), the STA 115-c may refrain from concurrently transmitting a second instance of the feedback message in a second portion of the bandwidth. For example, the STA 115-c may refrain from transmitting duplicates of the feedback message in a remaining portion of the bandwidth.

In some examples, at 420, the STA 115-c may transmit the feedback message in accordance with a first feedback message type (e.g., frequency-based duplication feedback, such as a non-high-throughput ACK message type) or a second feedback message type (e.g., non-duplicated feedback) based on a first transmit power associated with the first feedback type and a second transmit power associated with the second feedback type. For example, based on monitoring for the signal at 405, the STA 115-c may determine a difference value between the first transmit power and the second transmit power. The STA 115-c may compare the difference value to a threshold value (e.g., a feedback message transmit power threshold value) to determine whether the difference value satisfies a threshold associated with the threshold value. The STA 115-c may select a feedback message type for transmission of the feedback message based on the comparison.

If the difference value satisfies the threshold value, the STA 115-c may, at 420, transmit the feedback message in the first portion of the bandwidth according to the second feedback message type. Here, the STA 115-c may refrain from transmitting duplicates of the feedback message in the remaining portion of the bandwidth. For example, if the difference value is less than the threshold value, the STA 115-c may refrain from concurrently transmitting the second instance of the feedback message in the second portion of the bandwidth.

If the difference value fails to satisfy the threshold value, the STA 115-c may, at 420, transmit the feedback message according to the first feedback message type. For example, the STA 115-a may transmit the instance of the feedback message in the first portion of the bandwidth and may transmit the second instance of the feedback message in the second portion of the bandwidth. The instance of the feedback message may include or be an example of an ACK message, while the second instance of the feedback message may include or be an example of a duplicate of the ACK message. The instance of the feedback message and the second instance of the feedback message may span the bandwidth.

In some examples, at 425, the STA 115-c may monitor for a second signal from the AP 105-c, and may receive the second signal at 430. In some examples, at 435, the STA 115-c may compare a same characteristic of the second signal with a second threshold. For example, if the characteristic is the RSSI of the second signal, the second threshold may be a second RSSI threshold (e.g., −76 dBm). Additionally, or alternatively, if the characteristic is the coding rate of the second signal, the second threshold may be a second coding rate threshold (e.g., a quantity of spatial streams, such as two spatial streams).

In some examples, at 440, the STA 115-c may transmit a second feedback message (e.g., an ACK message, such as a non-high-throughput ACK message) pertaining to the second signal. The second feedback message may be transmitted with frequency-based duplication based on the characteristic of the second signal being greater than the second threshold. In some examples, the STA 115-c may transmit duplicates of the second feedback message in portions that span the bandwidth. For example, each duplicate of the second feedback message may span 20 MHz of an 80 MHz bandwidth or a 160 MHz bandwidth. The operations performed by the STA 115-c and the AP 105-c may support improvements to communication throughput and reliability, among other benefits.

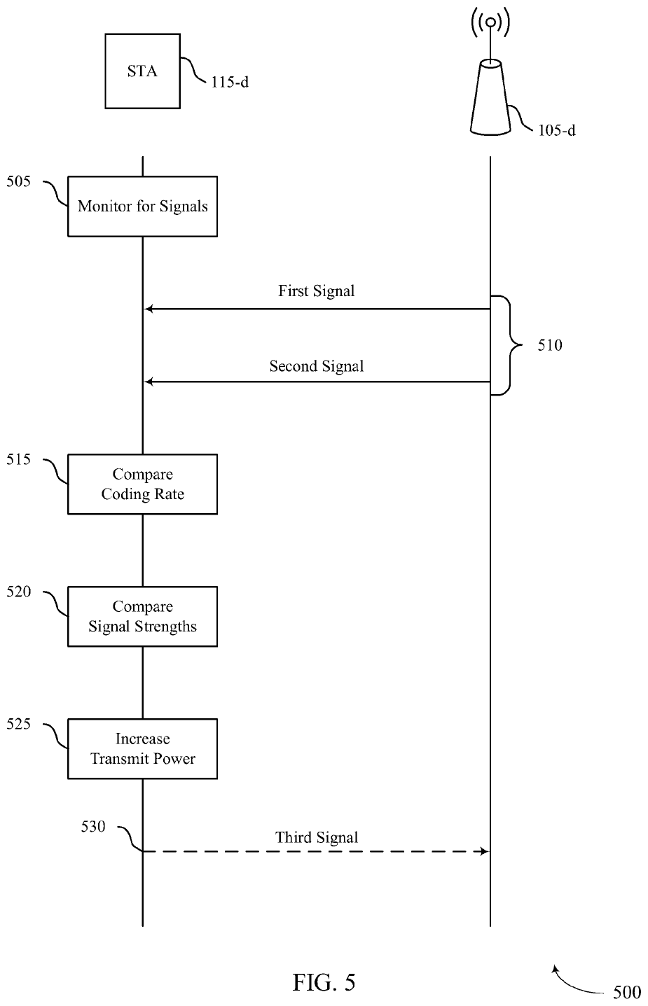

FIG. 5 illustrates an example of a process flow 500 that supports techniques for signal strength monitoring in accordance with one or more aspects of the present disclosure. In some examples, the process flow 500 may implement or be implemented by one or more aspects of wireless communications systems 100, 200, and 300. For example, the process flow 500 may include example operations associated with one or more of an AP 105-d or an STA 115-d, which may be examples of corresponding devices described with reference to FIGS. 1 through 3. In the following description of the process flow 500, the operations between the AP 105-d and the STA 115-d may be performed in a different order than the example order shown, or the operations performed by the AP 105-d and the STA 115-d may be performed in different orders or at different times. Some operations may also be omitted from the process flow 500, and other operations may be added to the process flow 500. The operations performed by the AP 105-d and the STA 115-d may support improvements to feedback operations and, in some examples, may promote improvements to communications reliability, among other benefits.

At 505, the STA 115-d may monitor for a first signal on a first transmission chain and for a second signal on a second transmission chain, where the STA 115-d and the AP 105-d may communicate using the transmission chains. In some examples, each transmission chain may be associated with a respective antenna at the STA 115-d. In some examples, the transmission chains may be connected.

At 510, the STA 115-d may receive the first signal and the second signal from the AP 105-d. In some examples, the first signal and the second signal may be instances of a same signal (e.g., instances of a DL message), or the first signal and the second signal may be different signals.

At 515, the STA 115-d may compare a coding rate with a rate threshold. The coding rate may be associated with the first signal, the second signal, or both. For example, the coding rate may be associated with an MCS of a set of packets received in the first signal, the second signal, or both. In some examples, the rate threshold may be an index associated with the MCS, such as MCS2. Additionally, or alternatively, the coding rate may be associated with a quantity of spatial streams associated with the transmission chains, and the rate threshold may be a quantity of spatial streams (e.g., two spatial streams).

At 520, the STA 115-d may determine a difference between a first RSSI of the first signal and a second RSSI of the second signal, and compare the difference with a difference threshold (e.g., 5 dB). In some examples, the STA 115-d may determine the difference based on monitoring for the first signal and the second signal.

At 525, the STA 115-d may increase a transmit power of the transmission

chain with the lower RSSI to give an extra link budget for transmissions to the AP 105-d. In some examples, the STA 115-d may increase a transmit power of the transmission chain with the lower RSSI by 2-3 dB to improve a UL throughput. The STA 115-d may increase the transmit power based on the coding rate being less than the rate threshold and the difference being greater than the difference threshold.

In some examples, at 530, the STA 115-d may transmit a third signal to the AP 105-d on the transmission chain with the lower RSSI according to the increased transmit power. The operations performed by the STA 115-d and the AP 105-d may support improvements to communication throughput and reliability, among other benefits.

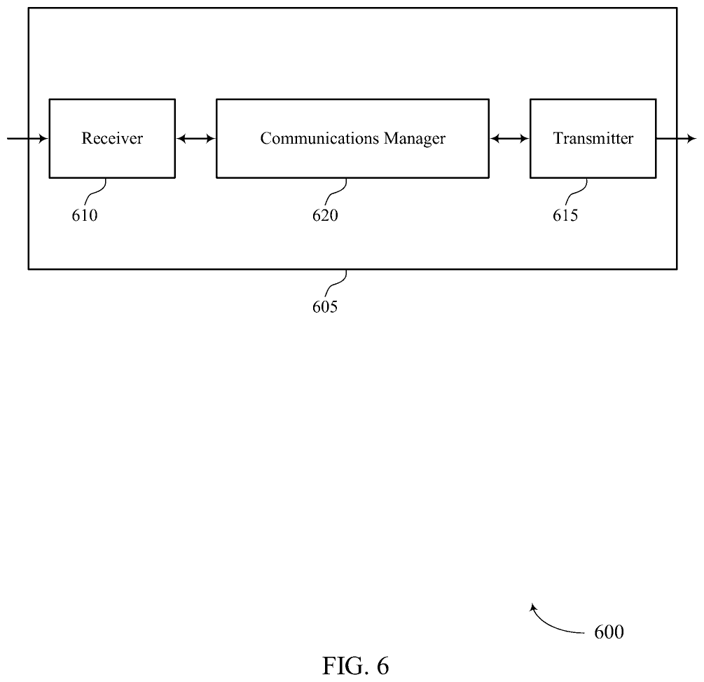

FIG. 6 shows a block diagram 600 of a device 605 that supports techniques for signal strength monitoring in accordance with one or more aspects of the present disclosure. The device 605 may be an example of aspects of an STA as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for signal strength monitoring). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for signal strength monitoring). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for signal strength monitoring as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a wireless station in accordance with examples as disclosed herein. For example, the communications manager 620 may be configured as or otherwise support a means for monitoring for a signal from an access point. The communications manager 620 may be configured as or otherwise support a means for comparing a characteristic of the signal with a threshold, the characteristic determined based on the monitoring and being one of a received signal strength indicator associated with the signal or a coding rate associated with a modulation and coding scheme of a set of packets received in the signal. The communications manager 620 may be configured as or otherwise support a means for transmitting a first instance of a feedback message pertaining to the signal in a first portion of a bandwidth. The communications manager 620 may be configured as or otherwise support a means for refraining, based on the characteristic being less than the threshold, from concurrently transmitting a second instance of the feedback message in a second portion of the bandwidth.

Additionally, or alternatively, the communications manager 620 may support wireless communication at a wireless station in accordance with examples as disclosed herein. For example, the communications manager 620 may be configured as or otherwise support a means for monitoring for a first signal from an access point and for a second signal from the access point using a first transmission chain of the wireless station and a second transmission chain of the wireless station, respectively. The communications manager 620 may be configured as or otherwise support a means for comparing, with a rate threshold, a coding rate that is determined based on the monitoring, the coding rate being associated with the first signal, the second signal, or both. The communications manager 620 may be configured as or otherwise support a means for comparing, with a difference threshold, a difference between a first received signal strength of the first signal and a second received signal strength of the second signal, the difference determined based on the monitoring. The communications manager 620 may be configured as or otherwise support a means for increasing a transmit power associated with the first transmission chain based on the coding rate being less than the rate threshold and on the difference being greater than the difference threshold, the first received signal strength of the first signal being less than the second received signal strength of the second signal.

Additionally, or alternatively, the communications manager 520 may support wireless communication at a wireless station in accordance with examples as disclosed herein. For example, the communications manager 520 is capable of, configured to, or operable to support a means for monitoring for a signal from an access point. The communications manager 520 is capable of, configured to, or operable to support a means for comparing a difference value between a first transmit power of a first feedback message type and a second transmit power of a second feedback message type to a threshold value, the first feedback message type and the second feedback message type associated with a feedback message pertaining to the signal. The communications manager 520 is capable of, configured to, or operable to support a means for transmitting, in a first portion of a bandwidth, a first instance of the feedback message in accordance with the first feedback type or the second feedback type based on the difference value satisfying the threshold value.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

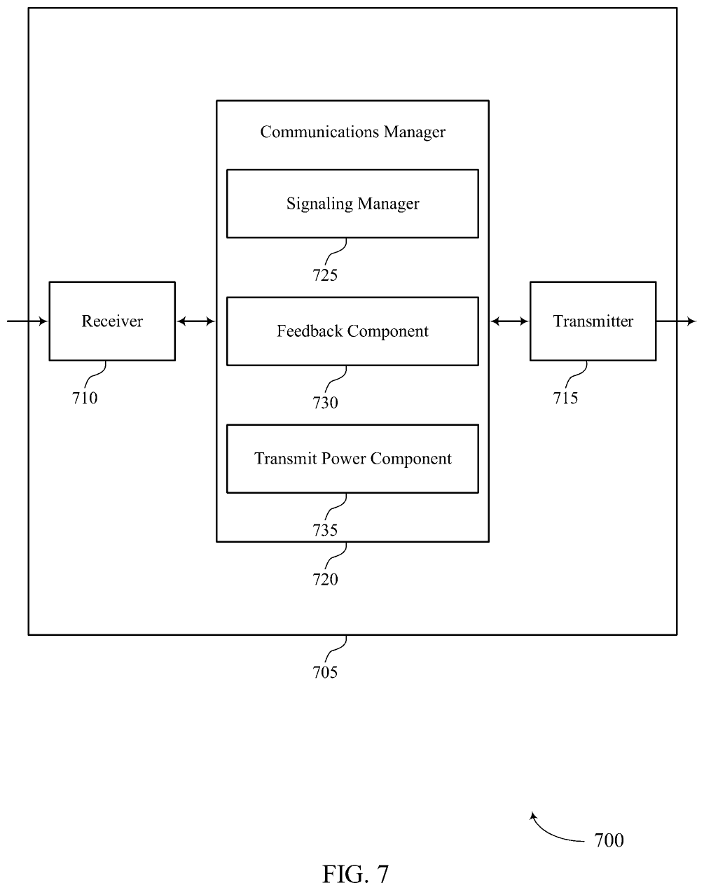

FIG. 7 shows a block diagram 700 of a device 705 that supports techniques for signal strength monitoring in accordance with one or more aspects of the present disclosure. The device 705 may be an example of aspects of a device 605 or an STA 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for signal strength monitoring). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for signal strength monitoring). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for signal strength monitoring as described herein. For example, the communications manager 720 may include a signaling manager 725, a feedback component 730, a transmit power component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a wireless station in accordance with examples as disclosed herein. The signaling manager 725 may be configured as or otherwise support a means for monitoring for a signal from an access point. The signaling manager 725 may be configured as or otherwise support a means for comparing a characteristic of the signal with a threshold, the characteristic determined based on the monitoring and being one of a received signal strength indicator associated with the signal or a coding rate associated with a modulation and coding scheme of a set of packets received in the signal. The feedback component 730 may be configured as or otherwise support a means for transmitting a first instance of a feedback message pertaining to the signal in a first portion of a bandwidth. The feedback component 730 may be configured as or otherwise support a means for refraining, based on the characteristic being less than the threshold, from concurrently transmitting a second instance of the feedback message in a second portion of the bandwidth.

Additionally, or alternatively, the communications manager 720 may support wireless communication at a wireless station in accordance with examples as disclosed herein. The signaling manager 725 may be configured as or otherwise support a means for monitoring for a first signal from an access point and for a second signal from the access point using a first transmission chain of the wireless station and a second transmission chain of the wireless station, respectively. The signaling manager 725 may be configured as or otherwise support a means for comparing, with a rate threshold, a coding rate that is determined based on the monitoring, the coding rate being associated with the first signal, the second signal, or both. The signaling manager 725 may be configured as or otherwise support a means for comparing, with a difference threshold, a difference between a first received signal strength of the first signal and a second received signal strength of the second signal, the difference determined based on the monitoring. The transmit power component 735 may be configured as or otherwise support a means for increasing a transmit power associated with the first transmission chain based on the coding rate being less than the rate threshold and on the difference being greater than the difference threshold, the first received signal strength of the first signal being less than the second received signal strength of the second signal.

Additionally, or alternatively, the communications manager 620 may support wireless communication at a wireless station in accordance with examples as disclosed herein. The signaling manager 625 is capable of, configured to, or operable to support a means for monitoring for a signal from an access point. The transmit power component 635 is capable of, configured to, or operable to support a means for comparing a difference value between a first transmit power of a first feedback message type and a second transmit power of a second feedback message type to a threshold value, the first feedback message type and the second feedback message type associated with a feedback message pertaining to the signal. The feedback component 630 is capable of, configured to, or operable to support a means for transmitting, in a first portion of a bandwidth, a first instance of the feedback message in accordance with the first feedback type or the second feedback type based on the difference value satisfying the threshold value.

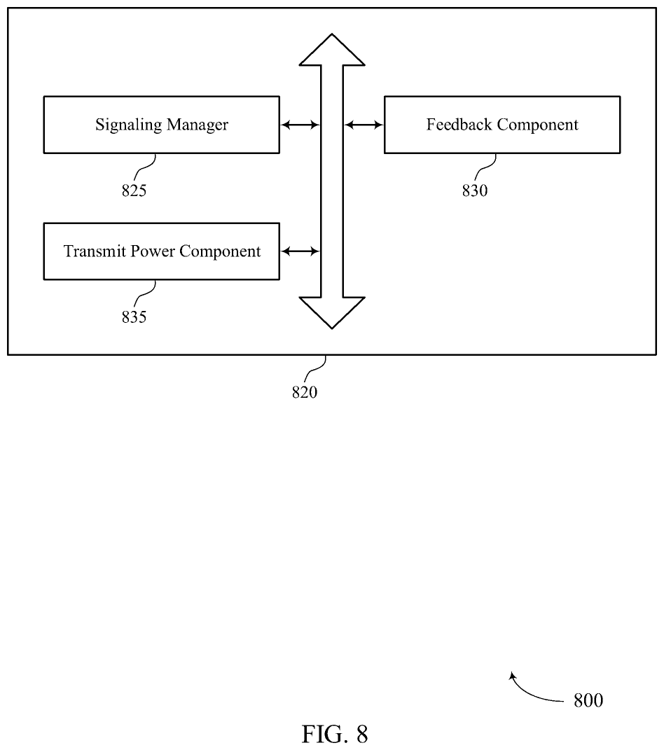

FIG. 8 shows a block diagram 800 of a communications manager 820 that supports techniques for signal strength monitoring in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for signal strength monitoring as described herein. For example, the communications manager 820 may include a signaling manager 825, a feedback component 830, a transmit power component 835, or any combination thereof. Each of these components may communicate, directly or indirectly, with one another (e.g., via one or more buses).

The communications manager 820 may support wireless communication at a wireless station in accordance with examples as disclosed herein. The signaling manager 825 may be configured as or otherwise support a means for monitoring for a signal from an access point. In some examples, the signaling manager 825 may be configured as or otherwise support a means for comparing a characteristic of the signal with a threshold, the characteristic determined based on the monitoring and being one of a received signal strength indicator associated with the signal or a coding rate associated with a modulation and coding scheme of a set of packets received in the signal. The feedback component 830 may be configured as or otherwise support a means for transmitting a first instance of a feedback message pertaining to the signal in a first portion of a bandwidth. In some examples, the feedback component 830 may be configured as or otherwise support a means for refraining, based on the characteristic being less than the threshold, from concurrently transmitting a second instance of the feedback message in a second portion of the bandwidth.

In some examples, the signaling manager 825 may be configured as or otherwise support a means for monitoring, after the transmitting, for a second signal from the access point. In some examples, the signaling manager 825 may be configured as or otherwise support a means for comparing, from the second signal and with a second threshold, a same characteristic as identified from the signal. In some examples, the feedback component 830 may be configured as or otherwise support a means for transmitting a second feedback message pertaining to the second signal, where the second feedback message is transmitted with frequency-based duplication based on the same characteristic being greater than the second threshold.

In some examples, the second feedback message spans the bandwidth.

In some examples, the second feedback message includes a non-high-throughput acknowledgment message.

In some examples, the threshold is a received signal strength indicator threshold and the characteristic is the received signal strength indicator associated with the signal.

In some examples, the threshold is a coding rate threshold and the characteristic is the coding rate associated with the modulation and coding scheme of the set of packets received in the signal.

In some examples, the coding rate is based on a quantity of spatial streams associated with the signal.

Additionally, or alternatively, the communications manager 820 may support wireless communication at a wireless station in accordance with examples as disclosed herein. In some examples, the signaling manager 825 may be configured as or otherwise support a means for monitoring for a first signal from an access point and for a second signal from the access point using a first transmission chain of the wireless station and a second transmission chain of the wireless station, respectively. In some examples, the signaling manager 825 may be configured as or otherwise support a means for comparing, with a rate threshold, a coding rate that is determined based on the monitoring, the coding rate being associated with the first signal, the second signal, or both. In some examples, the signaling manager 825 may be configured as or otherwise support a means for comparing, with a difference threshold, a difference between a first received signal strength of the first signal and a second received signal strength of the second signal, the difference determined based on the monitoring. The transmit power component 835 may be configured as or otherwise support a means for increasing a transmit power associated with the first transmission chain based on the coding rate being less than the rate threshold and on the difference being greater than the difference threshold, the first received signal strength of the first signal being less than the second received signal strength of the second signal.

In some examples, the transmit power component 835 may be configured as or otherwise support a means for transmitting a third signal to the access point using the first transmission chain of the wireless station according to the increased transmit power.

In some examples, the coding rate is based on a quantity of spatial streams associated with the first signal, the second signal, or both.

In some examples, the first signal includes a first instance of a downlink message. In some examples, the second signal includes a second instance of the downlink message.

In some examples, the first signal and the second signal are a same signal.

In some examples, the first transmission chain and the second transmission chain are associated with a multiple-input multiple-output configuration at the wireless station.

In some examples, the coding rate includes a combined coding rate associated with a modulation and coding scheme of a set of packets received in the first signal and the second signal.

In some examples, the coding rate is associated with a modulation and coding scheme of a set of packets received in the first signal.

Additionally, or alternatively, the communications manager 720 may support wireless communication at a wireless station in accordance with examples as disclosed herein. In some examples, the signaling manager 725 is capable of, configured to, or operable to support a means for monitoring for a signal from an access point. In some examples, the transmit power component 735 is capable of, configured to, or operable to support a means for comparing a difference value between a first transmit power of a first feedback message type and a second transmit power of a second feedback message type to a threshold value, the first feedback message type and the second feedback message type associated with a feedback message pertaining to the signal. In some examples, the feedback component 730 is capable of, configured to, or operable to support a means for transmitting, in a first portion of a bandwidth, a first instance of the feedback message in accordance with the first feedback type or the second feedback type based on the difference value satisfying the threshold value.

In some examples, the feedback component 730 is capable of, configured to, or operable to support a means for refraining from concurrently transmitting a second instance of the feedback message in a second portion of the bandwidth based on the difference value being less than the threshold value, where the first instance of the feedback message is transmitted in accordance with the second feedback type.

In some examples, the first instance of the feedback message spans the first portion of the bandwidth.

In some examples, the feedback component 730 is capable of, configured to, or operable to support a means for transmitting a second instance of the feedback message, where the first instance of the feedback message and the second instance of the feedback message are transmitted in accordance with the first feedback message type based on the difference value being greater than the threshold value.

In some examples, the first instance of the feedback message and the second instance of the feedback message are transmitted with frequency-based duplication.

In some examples, the first instance of the feedback message includes an acknowledgement message for the signal. In some examples, the second instance of the feedback message includes a duplicate of the acknowledgement message.

In some examples, the first feedback message type includes a non-high-throughput acknowledgment message type.

In some examples, the first instance of the feedback message and the second instance of the feedback message span the bandwidth.

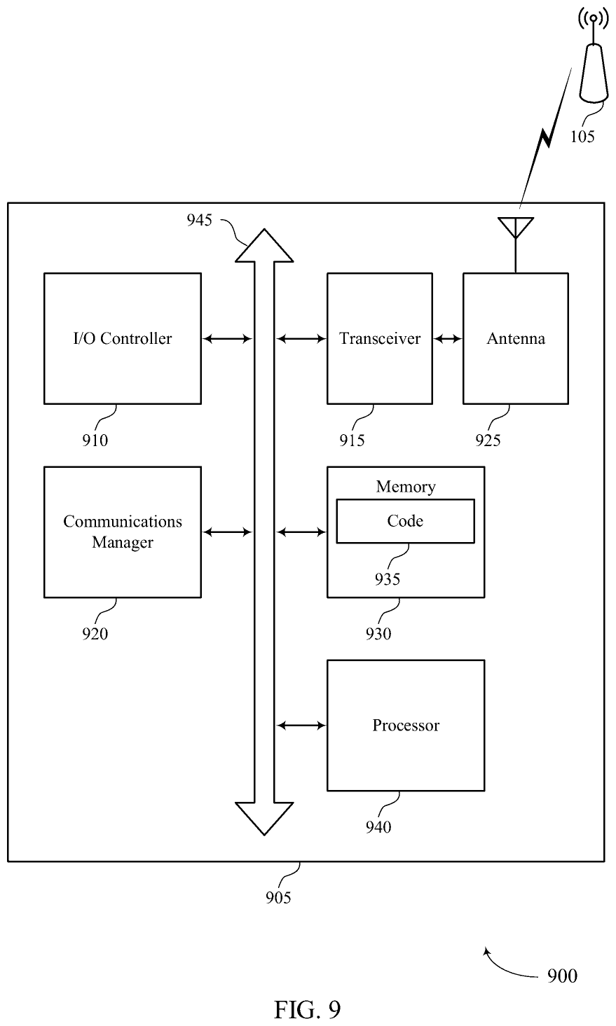

FIG. 9 shows a diagram of a system 900 including a device 905 that supports techniques for signal strength monitoring in accordance with one or more aspects of the present disclosure. The device 905 may be an example of or include the components of a device 605, a device 705, or an STA as described herein. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In some other cases, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets and provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random-access memory (RAM) and read-only memory (ROM). The memory 930 may store computer-readable, computer-executable code 935 including instructions that, when executed by the processor 940, cause the device 905 to perform various functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for signal strength monitoring). For example, the device 905 or a component of the device 905 may include a processor 940 and memory 930 coupled with or to the processor 940, the processor 940 and memory 930 configured to perform various functions described herein.

The communications manager 920 may support wireless communication at a wireless station in accordance with examples as disclosed herein. For example, the communications manager 920 may be configured as or otherwise support a means for monitoring for a signal from an access point. The communications manager 920 may be configured as or otherwise support a means for comparing a characteristic of the signal with a threshold, the characteristic determined based on the monitoring and being one of a received signal strength indicator associated with the signal or a coding rate associated with a modulation and coding scheme of a set of packets received in the signal. The communications manager 920 may be configured as or otherwise support a means for transmitting a first instance of a feedback message pertaining to the signal in a first portion of a bandwidth. The communications manager 920 may be configured as or otherwise support a means for refraining, based on the characteristic being less than the threshold, from concurrently transmitting a second instance of the feedback message in a second portion of the bandwidth.

Additionally, or alternatively, the communications manager 920 may support wireless communication at a wireless station in accordance with examples as disclosed herein. For example, the communications manager 920 may be configured as or otherwise support a means for monitoring for a first signal from an access point and for a second signal from the access point using a first transmission chain of the wireless station and a second transmission chain of the wireless station, respectively. The communications manager 920 may be configured as or otherwise support a means for comparing, with a rate threshold, a coding rate that is determined based on the monitoring, the coding rate being associated with the first signal, the second signal, or both. The communications manager 920 may be configured as or otherwise support a means for comparing, with a difference threshold, a difference between a first received signal strength of the first signal and a second received signal strength of the second signal, the difference determined based on the monitoring. The communications manager 920 may be configured as or otherwise support a means for increasing a transmit power associated with the first transmission chain based on the coding rate being less than the rate threshold and on the difference being greater than the difference threshold, the first received signal strength of the first signal being less than the second received signal strength of the second signal.

Additionally, or alternatively, the communications manager 820 may support wireless communication at a wireless station in accordance with examples as disclosed herein. For example, the communications manager 820 is capable of, configured to, or operable to support a means for monitoring for a signal from an access point. The communications manager 820 is capable of, configured to, or operable to support a means for comparing a difference value between a first transmit power of a first feedback message type and a second transmit power of a second feedback message type to a threshold value, the first feedback message type and the second feedback message type associated with a feedback message pertaining to the signal. The communications manager 820 is capable of, configured to, or operable to support a means for transmitting, in a first portion of a bandwidth, a first instance of the feedback message in accordance with the first feedback type or the second feedback type based on the difference value satisfying the threshold value.

By including or configuring the communications manager 920 in accordance with examples as described herein, the device 905 may support techniques for improved communication reliability, reduced latency, improved user experience related to reduced processing, more efficient utilization of communication resources, improved coordination between devices, and improved utilization of processing capability, among other benefits.

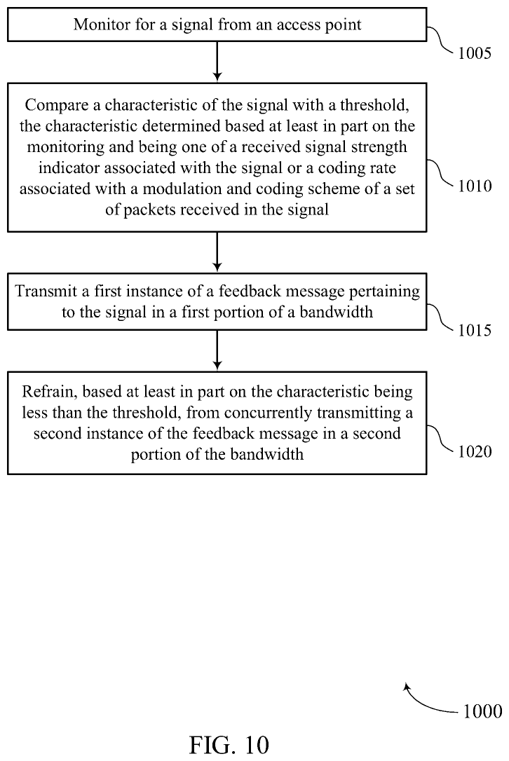

FIG. 10 shows a flowchart illustrating a method 1000 that supports techniques for signal strength monitoring in accordance with one or more aspects of the present disclosure. The operations of the method 1000 may be implemented by an STA or its components as described herein. For example, the operations of the method 1000 may be performed by an STA as described with reference to FIGS. 1 through 9. In some examples, an STA may execute a set of instructions to control the functional elements of the STA to perform the described functions. Additionally, or alternatively, the STA may perform aspects of the described functions using special-purpose hardware.

At 1005, the method may include monitoring for a signal from an access point. The operations of 1005 may be performed in accordance with examples as disclosed herein. In some examples, aspects of the operations of 1005 may be performed by a signaling manager 825 as described with reference to FIG. 8.

At 1010, the method may include comparing a characteristic of the signal with a threshold, the characteristic determined based on the monitoring and being one of a received signal strength indicator associated with the signal or a coding rate associated with a modulation and coding scheme of a set of packets received in the signal. The operations of 1010 may be performed in accordance with examples as disclosed herein. In some examples, aspects of the operations of 1010 may be performed by a signaling manager 825 as described with reference to FIG. 8.

At 1015, the method may include transmitting a first instance of a feedback message pertaining to the signal in a first portion of a bandwidth. The operations of 1015 may be performed in accordance with examples as disclosed herein. In some examples, aspects of the operations of 1015 may be performed by a feedback component 830 as described with reference to FIG. 8.

At 1020, the method may include refraining, based on the characteristic being less than the threshold, from concurrently transmitting a second instance of the feedback message in a second portion of the bandwidth. The operations of 1020 may be performed in accordance with examples as disclosed herein. In some examples, aspects of the operations of 1020 may be performed by a feedback component 830 as described with reference to FIG. 8.

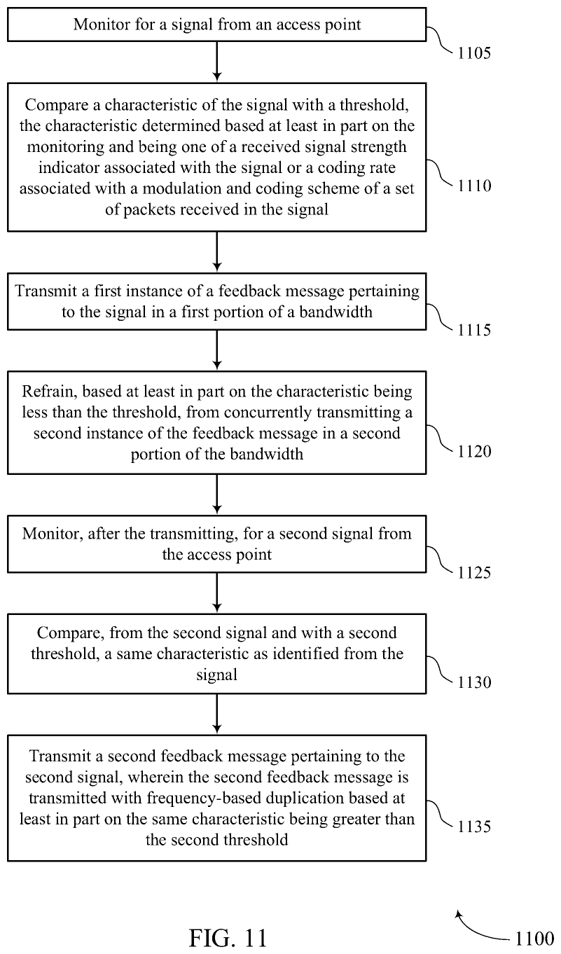

FIG. 11 shows a flowchart illustrating a method 1100 that supports

techniques for signal strength monitoring in accordance with one or more aspects of the present disclosure. The operations of the method 1100 may be implemented by an STA or its components as described herein. For example, the operations of the method 1100 may be performed by an STA as described with reference to FIGS. 1 through 9. In some examples, an STA may execute a set of instructions to control the functional elements of the STA to perform the described functions. Additionally, or alternatively, the STA may perform aspects of the described functions using special-purpose hardware.

At 1105, the method may include monitoring for a signal from an access point. The operations of 1105 may be performed in accordance with examples as disclosed herein. In some examples, aspects of the operations of 1105 may be performed by a signaling manager 825 as described with reference to FIG. 8.

At 1110, the method may include comparing a characteristic of the signal with a threshold, the characteristic determined based on the monitoring and being one of a received signal strength indicator associated with the signal or a coding rate associated with a modulation and coding scheme of a set of packets received in the signal. The operations of 1110 may be performed in accordance with examples as disclosed herein. In some examples, aspects of the operations of 1110 may be performed by a signaling manager 825 as described with reference to FIG. 8.

At 1115, the method may include transmitting a first instance of a feedback message pertaining to the signal in a first portion of a bandwidth. The operations of 1115 may be performed in accordance with examples as disclosed herein. In some examples, aspects of the operations of 1115 may be performed by a feedback component 830 as described with reference to FIG. 8.

At 1120, the method may include refraining, based on the characteristic being less than the threshold, from concurrently transmitting a second instance of the feedback message in a second portion of the bandwidth. The operations of 1120 may be performed in accordance with examples as disclosed herein. In some examples, aspects of the operations of 1120 may be performed by a feedback component 830 as described with reference to FIG. 8.

At 1125, the method may include monitoring, after the transmitting, for a second signal from the access point. The operations of 1125 may be performed in accordance with examples as disclosed herein. In some examples, aspects of the operations of 1125 may be performed by a signaling manager 825 as described with reference to FIG. 8.

At 1130, the method may include comparing, from the second signal and with a second threshold, a same characteristic as identified from the signal. The operations of 1130 may be performed in accordance with examples as disclosed herein. In some examples, aspects of the operations of 1130 may be performed by a signaling manager 825 as described with reference to FIG. 8.

At 1135, the method may include transmitting a second feedback message pertaining to the second signal, where the second feedback message is transmitted with frequency-based duplication based on the same characteristic being greater than the second threshold. The operations of 1135 may be performed in accordance with examples as disclosed herein. In some examples, aspects of the operations of 1135 may be performed by a feedback component 830 as described with reference to FIG. 8.

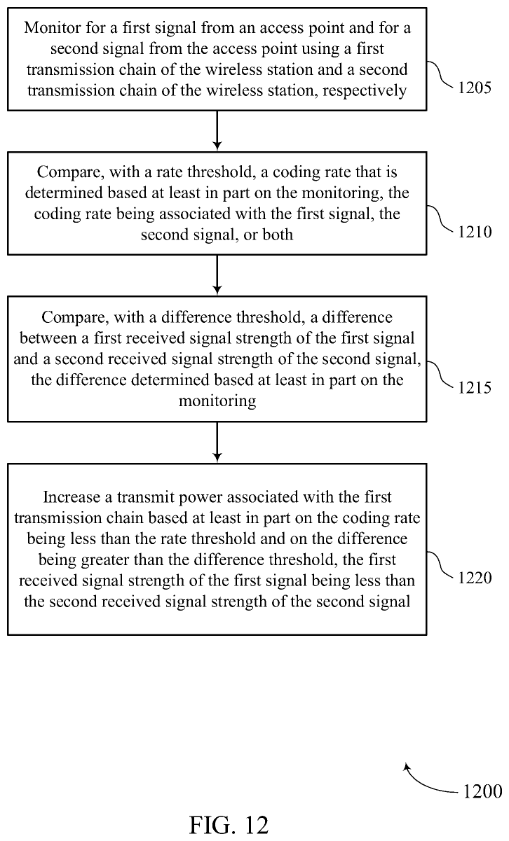

FIG. 12 shows a flowchart illustrating a method 1200 that supports techniques for signal strength monitoring in accordance with one or more aspects of the present disclosure. The operations of the method 1200 may be implemented by an STA or its components as described herein. For example, the operations of the method 1200 may be performed by an STA as described with reference to FIGS. 1 through 9. In some examples, an STA may execute a set of instructions to control the functional elements of the STA to perform the described functions. Additionally, or alternatively, the STA may perform aspects of the described functions using special-purpose hardware.

At 1205, the method may include monitoring for a first signal from an access point and for a second signal from the access point using a first transmission chain of the wireless station and a second transmission chain of the wireless station, respectively. The operations of 1205 may be performed in accordance with examples as disclosed herein. In some examples, aspects of the operations of 1205 may be performed by a signaling manager 825 as described with reference to FIG. 8.

At 1210, the method may include comparing, with a rate threshold, a coding rate that is determined based on the monitoring, the coding rate being associated with the first signal, the second signal, or both. The operations of 1210 may be performed in accordance with examples as disclosed herein. In some examples, aspects of the operations of 1210 may be performed by a signaling manager 825 as described with reference to FIG. 8.

At 1215, the method may include comparing, with a difference threshold, a difference between a first received signal strength of the first signal and a second received signal strength of the second signal, the difference determined based on the monitoring. The operations of 1215 may be performed in accordance with examples as disclosed herein. In some examples, aspects of the operations of 1215 may be performed by a signaling manager 825 as described with reference to FIG. 8.

At 1220, the method may include increasing a transmit power associated with the first transmission chain based on the coding rate being less than the rate threshold and on the difference being greater than the difference threshold, the first received signal strength of the first signal being less than the second received signal strength of the second signal. The operations of 1220 may be performed in accordance with examples as disclosed herein. In some examples, aspects of the operations of 1220 may be performed by a transmit power component 835 as described with reference to FIG. 8.

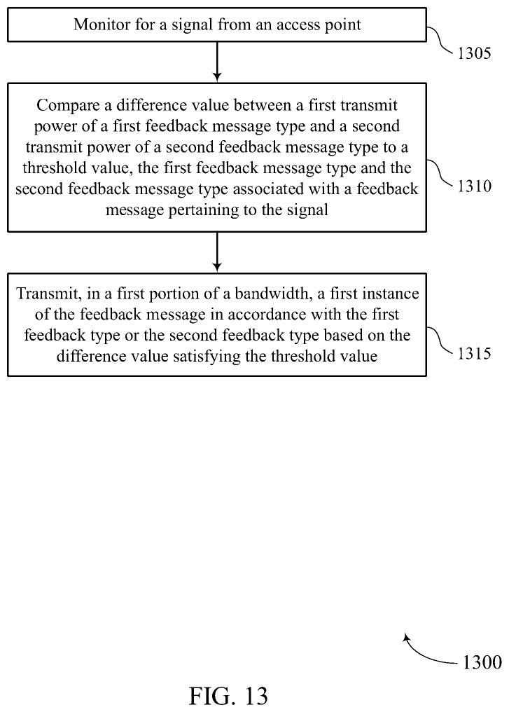

FIG. 13 shows a flowchart illustrating a method 1300 that supports techniques for signal strength monitoring in accordance with aspects of the present disclosure. The operations of the method 1300 may be implemented by a STA or its components as described herein. For example, the operations of the method 1300 may be performed by a STA as described with reference to FIGS. 1 through 9. In some examples, a STA may execute a set of instructions to control the functional elements of the wireless STA to perform the described functions. Additionally, or alternatively, the wireless STA may perform aspects of the described functions using special-purpose hardware.

At 1305, the method may include monitoring for a signal from an access point. The operations of block 1305 may be performed in accordance with examples as disclosed herein. In some examples, aspects of the operations of 1305 may be performed by a signaling manager 825 as described with reference to FIG. 8.

At 1310, the method may include comparing a difference value between a first transmit power of a first feedback message type and a second transmit power of a second feedback message type to a threshold value, the first feedback message type and the second feedback message type associated with a feedback message pertaining to the signal. The operations of block 1310 may be performed in accordance with examples as disclosed herein. In some examples, aspects of the operations of 1310 may be performed by a transmit power component 835 as described with reference to FIG. 8.

At 1315, the method may include transmitting, in a first portion of a bandwidth, a first instance of the feedback message in accordance with the first feedback type or the second feedback type based on the difference value satisfying the threshold value. The operations of block 1315 may be performed in accordance with examples as disclosed herein. In some examples, aspects of the operations of 1315 may be performed by a feedback component 830 as described with reference to FIG. 8.

The following provides an overview of aspects of the present disclosure:

Aspect 1: A method for wireless communication at a wireless station, comprising: monitoring for a signal from an access point; comparing a characteristic of the signal with a threshold, the characteristic determined based at least in part on the monitoring and being one of a received signal strength indicator associated with the signal or a coding rate associated with a modulation and coding scheme of a set of packets received in the signal; and transmitting a first instance of a feedback message pertaining to the signal in a first portion of a bandwidth; and refraining, based at least in part on the characteristic being less than the threshold, from concurrently transmitting a second instance of the feedback message in a second portion of the bandwidth.

Aspect 2: The method of aspect 1, further comprising: monitoring, after the transmitting, for a second signal from the access point; comparing, from the second signal and with a second threshold, a same characteristic as identified from the first signal; and transmitting a second feedback message pertaining to the second signal, wherein the second feedback message is transmitted with frequency-based duplication based at least in part on the same characteristic being greater than the second threshold.

Aspect 3: The method of aspect 2, wherein the second feedback message spans the bandwidth.

Aspect 4: The method of any of aspects 2 through 3, wherein the second feedback message comprises a non-high-throughput acknowledgement message.

Aspect 5: The method of any of aspects 1 through 4, wherein the threshold is a received signal strength indicator threshold and the characteristic is the received signal strength indicator associated with the signal.

Aspect 6: The method of any of aspects 1 through 5, wherein the threshold is a coding rate threshold and the characteristic is the coding rate associated with the modulation and coding scheme of the set of packets received in the signal.

Aspect 7: The method of aspect 6, wherein the coding rate is based at least in part on a quantity of spatial streams associated with the signal.

Aspect 8: A method for wireless communication at a wireless station, comprising: monitoring for a first signal from an access point and for a second signal from the access point using a first transmission chain of the wireless station and a second transmission chain of the wireless station, respectively; comparing, with a rate threshold, a coding rate that is determined based at least in part on the monitoring, the coding rate being associated with the first signal, the second signal, or both; comparing, with a difference threshold, a difference between a first received signal strength of the first signal and a second received signal strength of the second signal, the difference determined based at least in part on the monitoring; and increasing a transmit power associated with the first transmission chain based at least in part on the coding rate being less than the rate threshold and on the difference being greater than the difference threshold, the first received signal strength of the first signal being less than the second received signal strength of the second signal.

Aspect 9: The method of aspect 8, further comprising: transmitting a third signal to the access point using the first transmission chain of the wireless station according to the increased transmit power.

Aspect 10: The method of any of aspects 8 through 9, wherein the coding rate is based at least in part on a quantity of spatial streams associated with the first signal, the second signal, or both.

Aspect 11: The method of any of aspects 8 through 10, wherein the first signal comprises a first instance of a downlink message; and the second signal comprises a second instance of the downlink message.

Aspect 12: The method of any of aspects 8 through 11, wherein the first signal and the second signal are a same signal.

Aspect 13: The method of any of aspects 8 through 12, wherein the first transmission chain and the second transmission chain are associated with a multiple-input multiple-output configuration at the wireless station.

Aspect 14: The method of any of aspects 8 through 13, wherein the coding rate comprises a combined coding rate associated with a modulation and coding scheme of a set of packets received in the first signal and the second signal.

Aspect 15: The method of any of aspects 8 through 14, wherein the coding rate is associated with a modulation and coding scheme of a set of packets received in the first signal.

Aspect 16: A method for wireless communication at a wireless station, comprising: monitoring for a signal from an access point; comparing a difference value between a first transmit power of a first feedback message type and a second transmit power of a second feedback message type to a threshold value, the first feedback message type and the second feedback message type associated with a feedback message pertaining to the signal; and transmitting, in a first portion of a bandwidth, a first instance of the feedback message in accordance with the first feedback type or the second feedback type based at least in part on the difference value satisfying the threshold value.

Aspect 17: The method of aspect 16, further comprising: refraining from concurrently transmitting a second instance of the feedback message in a second portion of the bandwidth based at least in part on the difference value being less than the threshold value, wherein the first instance of the feedback message is transmitted in accordance with the second feedback type.

Aspect 18: The method of aspect 17, wherein the first instance of the feedback message spans the first portion of the bandwidth.

Aspect 19: The method of aspect 16, further comprising: transmitting a second instance of the feedback message, wherein the first instance of the feedback message and the second instance of the feedback message are transmitted in accordance with the first feedback message type based at least in part on the difference value being greater than the threshold value.

Aspect 20: The method of aspect 19, wherein the first instance of the feedback message and the second instance of the feedback message are transmitted with frequency-based duplication.

Aspect 21: The method of aspect 20, wherein the first instance of the feedback message comprises an acknowledgement message for the signal; and the second instance of the feedback message comprises a duplicate of the acknowledgement message.

Aspect 22: The method of any of aspects 19 through 21, wherein the first feedback message type comprises a non-high-throughput acknowledgment message type.

Aspect 23: The method of any of aspects 19 through 22, wherein the first instance of the feedback message and the second instance of the feedback message span the bandwidth.

Aspect 24: An apparatus for wireless communication at a wireless station, comprising a processor; memory coupled with the processor; and instructions stored in the memory and executable by the processor to cause the apparatus to perform a method of any of aspects 1 through 7.

Aspect 25: An apparatus for wireless communication at a wireless station, comprising at least one means for performing a method of any of aspects 1 through 7.

Aspect 26: A non-transitory computer-readable medium storing code for wireless communication at a wireless station, the code comprising instructions executable by a processor to perform a method of any of aspects 1 through 7.

Aspect 27: An apparatus for wireless communication at a wireless station, comprising a processor; memory coupled with the processor; and instructions stored in the memory and executable by the processor to cause the apparatus to perform a method of any of aspects 8 through 15.

Aspect 28: An apparatus for wireless communication at a wireless station, comprising at least one means for performing a method of any of aspects 8 through 15.

Aspect 29: A non-transitory computer-readable medium storing code for wireless communication at a wireless station, the code comprising instructions executable by a processor to perform a method of any of aspects 8 through 15.

Aspect 30: An apparatus for wireless communication at a wireless station, comprising a processor; memory coupled with the processor; and instructions stored in the memory and executable by the processor to cause the apparatus to perform a method of any of aspects 16 through 23.

Aspect 31: An apparatus for wireless communication at a wireless station, comprising at least one means for performing a method of any of aspects 16 through 23.

Aspect 32: A non-transitory computer-readable medium storing code for wireless communication at a wireless station, the code comprising instructions executable by a processor to perform a method of any of aspects 16 through 23.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a wireless station, comprising:
monitoring for a signal from an access point;
comparing a characteristic of the signal with a threshold, the characteristic determined based at least in part on the monitoring and being one of a received signal strength indicator associated with the signal or a coding rate associated with a modulation and coding scheme of a set of packets received in the signal;
transmitting a first instance of a feedback message pertaining to the signal in a first portion of a bandwidth; and
refraining, based at least in part on the characteristic being less than the threshold, from concurrently transmitting a second instance of the feedback message in a second portion of the bandwidth.

2. The method of claim 1, further comprising:
monitoring, after the transmitting, for a second signal from the access point;
comparing, from the second signal and with a second threshold, a same characteristic as identified from the signal; and
transmitting a second feedback message pertaining to the second signal, wherein the second feedback message is transmitted with frequency-based duplication based at least in part on the same characteristic being greater than the second threshold.

3. The method of claim 2, wherein the second feedback message spans the bandwidth.

4. The method of claim 2, wherein the second feedback message comprises a non-high-throughput acknowledgment message.

5. The method of claim 1, wherein the threshold is a received signal strength indicator threshold and the characteristic is the received signal strength indicator associated with the signal.

6. The method of claim 1, wherein the threshold is a coding rate threshold and the characteristic is the coding rate associated with the modulation and coding scheme of the set of packets received in the signal.

7. The method of claim 6, wherein the coding rate is based at least in part on a quantity of spatial streams associated with the signal.

8. A method for wireless communication at a wireless station, comprising:
monitoring for a first signal from an access point and for a second signal from the access point using a first transmission chain of the wireless station and a second transmission chain of the wireless station, respectively;
comparing, with a rate threshold, a coding rate that is determined based at least in part on the monitoring, the coding rate being associated with the first signal, the second signal, or both;
comparing, with a difference threshold, a difference between a first received signal strength of the first signal and a second received signal strength of the second signal, the difference determined based at least in part on the monitoring; and
increasing a transmit power associated with the first transmission chain based at least in part on the coding rate being less than the rate threshold and on the difference being greater than the difference threshold, the first received signal strength of the first signal being less than the second received signal strength of the second signal.

9. The method of claim 8, further comprising:
transmitting a third signal to the access point using the first transmission chain of the wireless station according to the increased transmit power.

10. The method of claim 8, wherein the coding rate is based at least in part on a quantity of spatial streams associated with the first signal, the second signal, or both.

11. The method of claim 8, wherein:
the first signal comprises a first instance of a downlink message; and
the second signal comprises a second instance of the downlink message.

12. The method of claim 8, wherein the first signal and the second signal are a same signal.

13. The method of claim 8, wherein the first transmission chain and the second transmission chain are associated with a multiple-input multiple-output configuration at the wireless station.

14. The method of claim 8, wherein the coding rate comprises a combined coding rate associated with a modulation and coding scheme of a set of packets received in the first signal and the second signal.

15. The method of claim 8, wherein the coding rate is associated with a modulation and coding scheme of a set of packets received in the first signal.

16. A method for wireless communication at a wireless station, comprising:
monitoring for a signal from an access point;
comparing a difference value between a first transmit power of a first feedback message type and a second transmit power of a second feedback message type to a threshold value, the first feedback message type and the second feedback message type associated with a feedback message pertaining to the signal; and
transmitting, in a first portion of a bandwidth, a first instance of the feedback message in accordance with the first feedback type or the second feedback type based at least in part on the difference value satisfying the threshold value.

17. The method of claim 16, further comprising:
refraining from concurrently transmitting a second instance of the feedback message in a second portion of the bandwidth based at least in part on the difference value being less than the threshold value, wherein the first instance of the feedback message is transmitted in accordance with the second feedback type.

18. The method of claim 17, wherein the first instance of the feedback message spans the first portion of the bandwidth.

19. The method of claim 16, further comprising:
transmitting a second instance of the feedback message, wherein the first instance of the feedback message and the second instance of the feedback message are transmitted in accordance with the first feedback message type based at least in part on the difference value being greater than the threshold value.

20. The method of claim 19, wherein the first instance of the feedback message and the second instance of the feedback message are transmitted with frequency-based duplication.

21. The method of claim 20, wherein:
the first instance of the feedback message comprises an acknowledgement message for the signal; and
the second instance of the feedback message comprises a duplicate of the acknowledgement message.

22. The method of claim 19, wherein the first feedback message type comprises a non-high-throughput acknowledgment message type.

23. The method of claim 19, wherein the first instance of the feedback message and the second instance of the feedback message span the bandwidth.

24. An apparatus for wireless communication at a wireless station, comprising:
a processor;
memory coupled with the processor; and
instructions stored in the memory and executable by the processor to cause the apparatus to:
monitor for a signal from an access point;
compare a characteristic of the signal with a threshold, the characteristic determined based at least in part on the monitoring and being one of a received signal strength indicator associated with the signal or a coding rate associated with a modulation and coding scheme of a set of packets received in the signal;
transmit a first instance of a feedback message pertaining to the signal in a first portion of a bandwidth; and
refrain, based at least in part on the characteristic being less than the threshold, from concurrently transmitting a second instance of the feedback message in a second portion of the bandwidth.

25. The apparatus of claim 24, wherein the instructions are further executable by the processor to cause the apparatus to:
monitor, after the transmitting, for a second signal from the access point;
compare, from the second signal and with a second threshold, a same characteristic as identified from the signal; and
transmit a second feedback message pertaining to the second signal, wherein the second feedback message is transmitted with frequency-based duplication based at least in part on the same characteristic being greater than the second threshold.

26. The apparatus of claim 25, wherein the second feedback message spans the bandwidth.

27. The apparatus of claim 25, wherein the second feedback message comprises a non-high-throughput acknowledgment message.

28. The apparatus of claim 24, wherein the threshold is a received signal strength indicator threshold and the characteristic is the received signal strength indicator associated with the signal.

29. The apparatus of claim 24, wherein the threshold is a coding rate threshold and the characteristic is the coding rate associated with the modulation and coding scheme of the set of packets received in the signal.

30. The apparatus of claim 29, wherein the coding rate is based at least in part on a quantity of spatial streams associated with the signal.
